(19) United States
(12) Patent Application Publication
(10) Pub. No.: US 2009/0313869 A1
(43) Pub. Date: Dec. 24, 2009

(54) DEVICE FOR PRODUCING LIGHT AND ITS APPLICATIONS TO LIGHTING AND LIGHTED SIGNAGE

(75) Inventors: Jaouad Zemmouri, Genech (FR); Jean Ringot, Mons En Baroeul (FR)

Correspondence Address: HARNESS, DICKEY & PIERCE, P.L.C., P.O. BOX 828, BLOOMFIELD HILLS, MI, 48303, US

(73) Assignees: Regenerer, Tourcoing (FR); Optical System & Research for Industry and Science Osyris, Hellemmes (FR)

(21) Appl. No.: 12/375,180

(22) PCT Filed: Jul. 27, 2007
(86) PCT No.: PCT/FR2007/001299

§ 371 Date: Mar. 19, 2009

(30) Foreign Application Priority Data
Jul. 27, 2006 (FR) 06/06894

(51) Int. Cl. G09F 13/00; F21V 8/00

(52) U.S. Cl. 40/541; 362/558

(57) ABSTRACT

The light production device includes at least one first light source associated with a principal waveguide. The principal waveguide includes an envelope for the propagation of the light, that has an index of refraction higher than the index of refraction of the internal part of the principal guide in contact with the envelope; the device includes optical injection means that are difference from the principal waveguide, the length of which is less than the length of the principal waveguide, and which allow at least a part of the light produced to be injected into said envelope of the principal waveguide, and diffusion means suitable for diffusing toward the exterior of the envelope, on at least a portion of the envelope of predefined length, at least a part of the light circulating in the envelope of the principal guide.

### FIELD OF THE INVENTION

The present invention refers to a device for producing light constituting a new extended light source. It is mainly applicable in the field of lighting and in the field of lighted signage as an extended light source, used for example for retro-lighting or shaped to constitute a piece of illuminated information.

### PRIOR ART

In the field of lighting and in the field of lighted signage, fluorescent or neon tubes are normally used as extended or homogeneous light sources. In particular, in the field of lighted signage, luminous signs, so-called “drapeau” signs, of the sort like a pharmacy's cross or similar, are destined to be fixed to an exterior support (a wall or similar), to be orientated perpendicularly to this support and to be positioned in a substantially vertical plane. These luminous signs include neon tubes that form at least one luminous pattern on the two sides of the sign. One double-sided luminous sign with neon tubes, of the pharmacy's cross type, is described for example in French patent applications FR 2 765 996 and FR 2 776 810. Neon tubes can also be used in other types of luminous signs in order to realise back-lighting (retro-lighting) of a translucent support bearing information or a pattern highlighted by retro-lighting.

Neon tubes present, however, at least two major disadvantages. They contain a toxic gas, which complicates their recycling, and their manufacture is complex because of the need to manufacture a tube containing a gas under vacuum.

Elsewhere, in International Patent Application WO 93/24787, a light source has been proposed that includes a light element associated with a tubular, rectilinear wave guide and with an absorber element that allows the light rays that possess an angle of emission above a predefined angle to be absorbed. In this type of light source, the light waves are propagated by successive reflections in the interior of the central cavity of the tubular guide. This type of light source can be suitable when the tubular wave guide is rectilinear. On the other hand, this type of light source is inappropriate when the guide is not rectilinear, as when it is curved, for example. Indeed, a part of the light rays escapes from the wave guide in the curves, to the detriment of the light output of this type of source. Moreover, the absorber element leads to a significant loss of light output.

### OBJECTIVES OF THE INVENTION

The present invention aims to propose a new extended light source that compensates for the disadvantages of neon tubes cited above, and which can in particular be substituted for neon tubes.

Another objective of the invention is to propose an extended light source that can be rectilinear or that can have a relatively complex curved shape, as the case may be.

### SUMMARY OF THE INVENTION

This objective is achieved by means of a device for producing light according to Claim 1. This device includes at least one first light source associated with a principal wave guide; the principal wave guide includes an envelope for propagating light that possesses an index of refraction (n1) greater than the index of refraction (n2) of the internal part of the principal guide that is in contact with the envelope. The device also includes:
optical injection means that are separate from the principal wave guide, the length (d) of which is less than the length of the principal wave guide, and which allows at least a part of the light produced to be injected into said envelope of the principal wave guide, and
diffusion means that are suitable for diffusing at least a part of the light circulating in the envelope of the principal guide towards the exterior of the envelope, on at least a portion of the envelope with a predefined length L.

More particularly, but not necessarily, the device of the invention includes the additional and optional characteristics mentioned in Claims 2 to 22.

According to another aspect of the invention, the device for producing light includes at least one first light source associated with a principal wave guide; the principal wave guide includes an envelope for propagating light that possesses an index of refraction (n1) greater than the index of refraction (n2) of the internal part of the principal guide that is in contact with the envelope. The light source forms a ring of light positioned in front of the entrance of the principal wave guide, such that the produced light is injected directly into the envelope of the wave guide. The device also includes diffusion means that are suitable for diffusing at least a part of the light circulating in the envelope of the principal guide towards the exterior of the envelope, on at least a portion of the envelope with a predefined length L.

More particularly, for the formation of said ring of light, in one embodiment of the invention the light source includes several light elements arranged in the form of a ring. In a second embodiment of the invention, the light source is associated with optical collimation means, for example a reflector, which allows the light rays produced by the source to be collimated in the form of a ring of light.

The invention also has as its objective the use of a device for producing light mentioned above as a direct means of lighting, or as a means of retro-lighting, or as a means of lighted signage.

The invention has as a further objective a lighted signage device, in particular a luminous sign (forming, for example, a pharmacy's cross), including at least one device for producing light as mentioned above.

### BRIEF DESCRIPTION OF THE DRAWINGS

The attached drawings represent several preferred embodiments of the device for producing light according to the invention, said embodiments being given as non-exhaustive and non-limiting examples of the invention. In the attached drawings:

FIG. 1 is a longitudinal section of a first embodiment of a device for producing light, according to the invention,

FIG. 2 shows the incident, annular light beam produced by the light source of the device of FIG. 1, at the level of entry of the light beam into the wave guide,

FIG. 3 is a transversal section of the device of FIG. 1 along the plane III-III,

FIG. 4 shows in schematic form the path of the light rays in the interior of the wall of the injector of the device of FIG. 1,

FIG. 5 is a longitudinal section of a second embodiment of a device for producing light, according to the invention,

FIG. 6 is a longitudinal section of a third embodiment of a device for producing light, according to the invention,

FIG. 7 is a front view of a light source, including diodes arranged in a ring,

FIG. 8 is a longitudinal section of a fourth embodiment of a device for producing light, according to the invention, implementing the source of FIG. 7, and not including optical injection means,

FIG. 9 is a longitudinal section of a fifth embodiment of a device for producing light, according to the invention,

FIG. 10 is a longitudinal section of a sixth embodiment of a device for producing light, according to the invention,

FIG. 11 is a longitudinal section of a seventh embodiment of a device for producing light, according to the invention, implementing an axicon with a single cylindrical lens,

FIG. 12 is a longitudinal section of an eighth embodiment of a device for producing light, according to the invention, implementing an axicon with two cylindrical lens.

### DETAILED DESCRIPTION

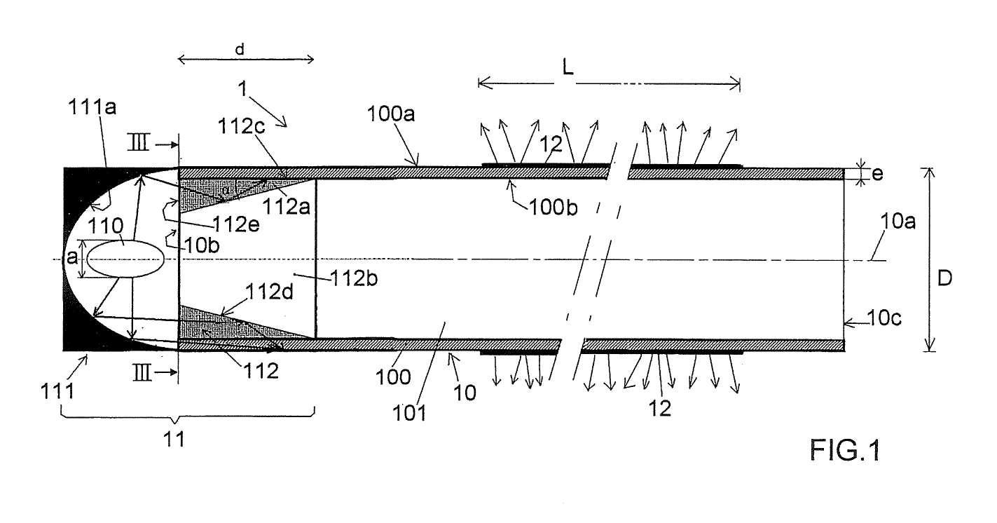

A first particular embodiment example of a device for producing light 1 according to the invention is shown in FIG. 1. This device 1 includes a principal wave guide 10 that is associated with a light source 11.

In this particular embodiment of the invention, the wave guide 10 is constituted by a hollow tube, preferably with a circular cross section and having a central axis of symmetry 10a. This tube 10 includes a tubulaire wall 100 with a thickness e. The internal cavity 101 of the tube 10 contains air. The wall 100 of the tube 10 is made of a material that has an index of refraction n1 greater than the index of refraction n2 of the part of the cavity 101 that is in contact with the wall 100, namely when air is present (n2=1). The function of this wall 100 is to act as an envelope for guiding and propagating light. The wall 100 is preferably made from any material that is transparent in the range of visible wave lengths (between 400 nm and 800 nm). For example, the wall 100 of the tube 10 is made of glass or of a polymer material.

The light source 11 includes a point light source 110 that emits preferably in the range of visible wave lengths (between 400 nm and 800 nm), and is associated with a reflector 111. The point light source 110 is positioned near one 10b of the end faces of the tube 10, preferably being centred on the central axis of symmetry 10a of the tube 10. The point light source 110 is constituted for example by a light bulb, or a group of light bulbs, by an electroluminescent diode or a group of electroluminescent diodes, or by any light element, or group of light elements.

In the present text the term “point” light source is understood to refer to a light source of which the transversal dimension (a) is less than dimension D (the diameter of the tube 10) of the cross section of the wave guide 10.

The reflector 111 includes a reflecting surface 111a that is preferably, but not necessarily, of parabolic shape. This reflecting surface la is for example a metallic mirror. The point light source 110 is positioned between this reflecting surface 111a and the end face 10b of the tube 10. The reflecting surface 111a preferably has a central axis of symmetry and is centred with relation to the tube 10, the central axis of symmetry of the reflecting surface 111a being merged with the central axis of symmetry 10a of the tube.

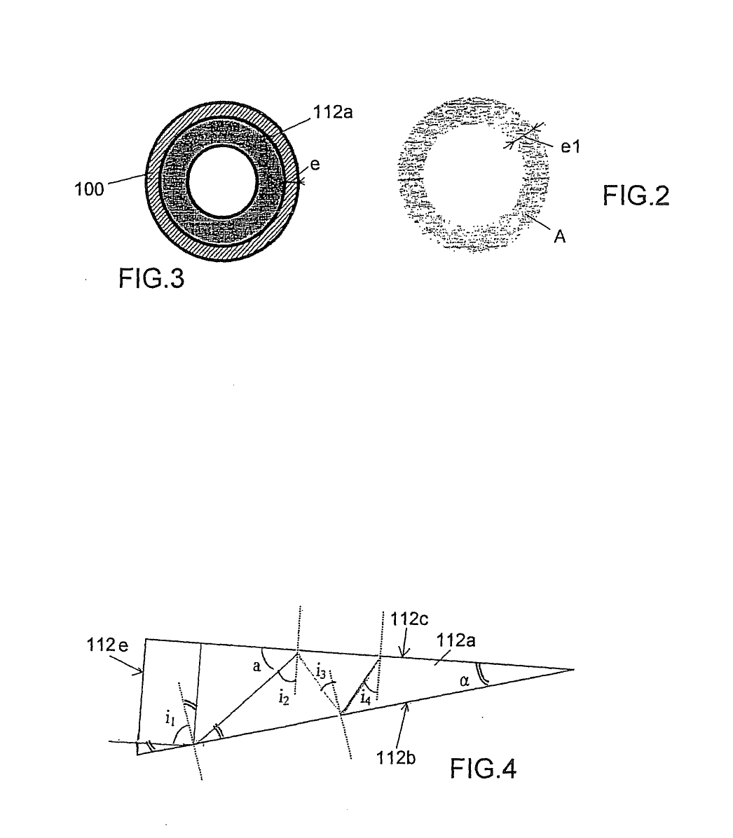

In operation, the light rays produced by the point light source 110 are reflected and collimated in the direction of the end face 10b of the tube 10 in the form of a ring of light (A), which is centred with relation to the tube 10 and which is shown in FIG. 2.

In this particular embodiment example of FIG. 1, the light source 11 also includes optical injection means 112 of length (d), which is short and less than the length of the wave guide 10. In this particular example, the optical injection means are constituted by an injector 112 made in the form of a hollow, one-piece insert. This insert 112 is preferably made of a material that has an index of refraction n3 that is less than the index of refraction n1 of the wall 100 of the guide 10, and is nested in the guide 10 at the level of its extremity 10b. This insert 112 has a central axis of symmetry and is centred on the central axis of symmetry 10a of the tube 10. This insert 112 is a hollow piece including a wall 112a the thickness of which decreases substantially linearly (FIG. 1/angle α between the external cylindrical surface 112c of the internal surface 112d of the injector 112) from the entrance face 10b of the guide 10, an internal cavity 112b containing air and in the shape of a truncated cone, and an external cylindrical surface 112c. The external surface 112c of the insert 112 is in contact with the internal surface 100b of the wall 100 of the guide 10 along the entire length of the insert 112.

In another embodiment, it is also possible to use an insert 112 that has an index of refraction n3 greater than the index of refraction n1 of the wall 100 of the guide 10. In this case, a fine intermediate layer is foreseen between the external surface 112c of the insert and the internal surface 100b of the wall 100 of the guide 10, said layer being made of a material that has an index of refraction less than the index of refraction of the wall 100 of the guide 10. This fine intermediate layer comes in the form of a glue or a gel, or in the form of a film. In this embodiment, the injector is constituted by the insert 112 and by this intermediate layer for adaptation of the index at the interface between the insert 112 and the wall 100.

In general, the injector 112 is designed and arranged with relation to the tube 10 and with relation to the light source 110/reflector 111 assembly in such a way that the incident light beam A delivered by this assembly is guided and introduced, at least partially, in the wall 100 of the tube 10.

Preferably, the injector 112 is designed and arranged with relation to the tube 10 and to the light source 110/reflector 111 assembly in such a way that a maximum of incident light intensity delivered by the light source 11 is introduced into the wall 100 of the guide 10 and in particular at least 50% and more preferably at least 70% of the incident light intensity delivered by the light source 11 is introduced into the wall 100 of the tube 10.

FIG. 3 shows the cross section of the tube 10 and of the injector 112. When this FIG. 3 is compared with the ring of light shown in FIG. 2, one can see that the thickness (el) of the light ring A is greater than the thickness (e) of the wall of the tube 10. The injector 112 allows the light rays corresponding to this ring of light A to be guided by successive internal reflections (see FIG. 4), such as to conduct them progressively to the interior of the wall 100 of the tube 10.

Once a light ray produced by the source 11 penetrates into the wall 112a of the injector 112, it propagates in the wall 112a of this injector by successive reflections until the condition of total reflection is no longer met (FIG. 4).

Studies have been carried out on the injector 112 in order to determine which angle α allows the best injection output to be obtained, namely which allows the introduction into the wall 101 of the tube 10, of the maximum light intensity for a given source 11.

These studies have shown that with an injector constituted by an insert 112 made of a material such as PMMA (methyl polymethacrylate with an index of refraction n3 with a value of 1.49) or such as polycarbonate (index of refraction n3 with a value of 1.58) and by an intermediate layer with an index of refraction of the order of for example 1.45, and with a tube 10 made of a material such as glass (Pyrex®/index of refraction n1 with a value of 1.47), it is preferable that the angle α is less than or equal to 11° and preferably substantially equal to 11°, in order to receive, from the second reflection (i2) onwards [FIG. 4], a transfer of light intensity in the wall 100 of the tube 10.

Once the beams of light have been introduced into the wall 100 of the tube 10, they propagate in this wall by successive total reflections because of the difference between the index of refraction n1 of the wall 100 of the tube 10 and that n2 of the air. The wall 100 of the tube 10 acts therefore as a wave guide. As long as the tube 10 has no surface defects or any particles in the wall 100 that constitute obstacles leading to a diffusion of the light, then all the light will propagate in the wall 100 of the tube 10, without leaving this wall.

According to its use, the tube 10 can be rectilinear along its entire length or it can have a relatively complex curved shape.

Advantageously, according to the invention, the propagation of the light rays is realised by multiple reflections in the wall 100 of the tube of limited thickness (e), when the tube has at least one curved part, the angle of incidence of the light rays remaining less than the limiting propagation angle in this curved part, and these light rays do not leave the wall 100 of the tube 10, as long as said wall does not include any means for diffusing the light.

Preferably, the thickness (e) of the wall 100 of the tube 10 is comprised between 1 mm and 3 mm.

In order for the device 1 to be able to act as an extended light source, the tube 10 is associated with at least diffusion means 12 that extend for a given length L, and which are preferably located outside the injection region of the optical injection means 112.

These diffusion means 12 can take several different forms, the important thing being that they allow a diffusion of the light from the interior of the wall 100 of the tube 10 to the exterior of the tube 10.

These diffusion means 12 can include diffusing elements (for example in the form of paint, coating, powder . . . ) applied to the external surface 100a of the wall 100 of the tube 10, and/or on the internal surface 100b of the wall 100 of the tube 10. The application of diffusing elements (for example in the form of paint, coating, powder . . . ) on the internal surface 100b of the wall 100 of the tube 10 advantageously allows these diffusing elements to be protected.

These diffusion means 12 can also include diffusing elements (for example metal particles, air bubbles) in the interior of the wall 100 of the tube 10.

These diffusion means 12 can also appear in the form of surface roughness or unevenness.

According to its use, the diffusion means 12 can extend over a single diffusion zone of predefined length L, or over several distinct, spaced-apart zones depending on the length of the tube 10.

When it is desired to obtain a light source that is not only extended but also homogeneous, it is advisable to design the diffusion means 12 so as to obtain a uniform light (substantially constant light intensity) over the entire diffusion surface corresponding to these means 12.

Several technical solutions can be used in order to obtain a homogeneous diffusion. Two solutions are given hereinafter as non-exhaustive and non-limiting examples according to the invention.

The diffusing elements of the diffusion means 12 can be distributed in such a way that their concentration is substantially constant over the entire diffusion surface (of length L) of the diffusion means 12; for example, a layer of paint of constant thickness, or powder with a constant weight per surface unit, can be applied. In this case, it is preferable that the concentration is weak.

The concentration of the diffusing elements in function of their distance from the light source 11 can also be modulated, namely the concentration is increased with the distance in order to compensate for the loss of incident light intensity.

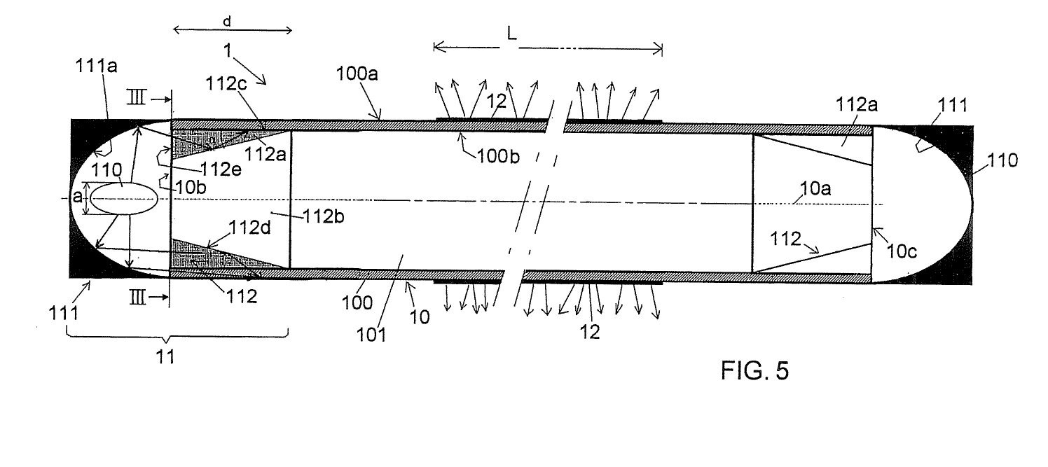

According to the invention, for improving the light output, it is preferable, in accord with the embodiment of FIG. 5, to associate a second reflector 111 with the tube 10, said reflector being mounted at the extremity 10c of the tube 10 opposite to the source 110, and which can for example be identical to the first reflector 111. This second reflector 111 allows light losses to be reduced, by reflecting the light rays escaping from the extremity 10c of the tube in the direction of the tube 10. It is even more preferable to associate a second injector 112 (FIG. 5) with this second reflector 111, said injector fulfilling the same function for the light rays reflected by the second reflector 111 at the extremity 10c of the tube 10, as the first injector 112 for the incident light rays delivered by the source 110.

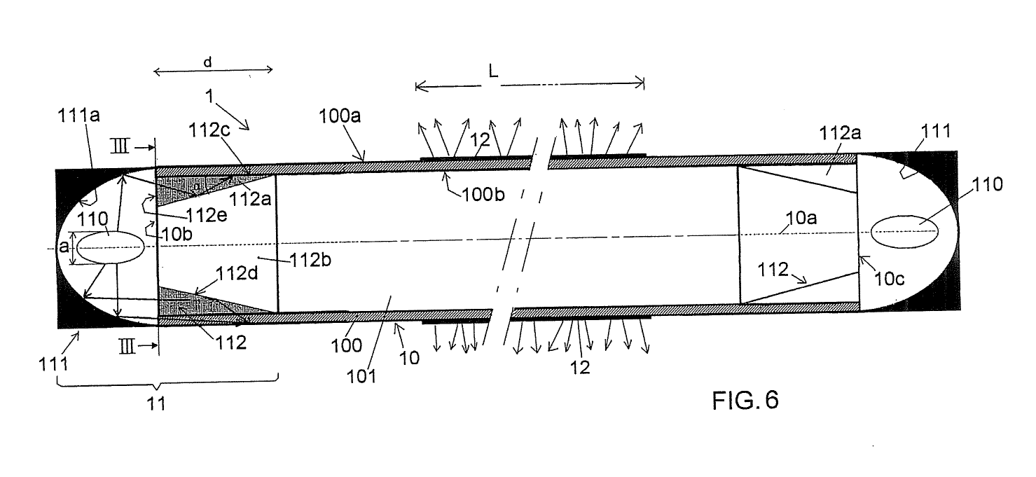

It is even more preferable, in a further, advanced embodiment, such as that shown in FIG. 6, to improve on the device of FIG. 5 by adding a second, supplementary point light source 110 between the second reflector 111 and the extremity 10c of the tube 10.

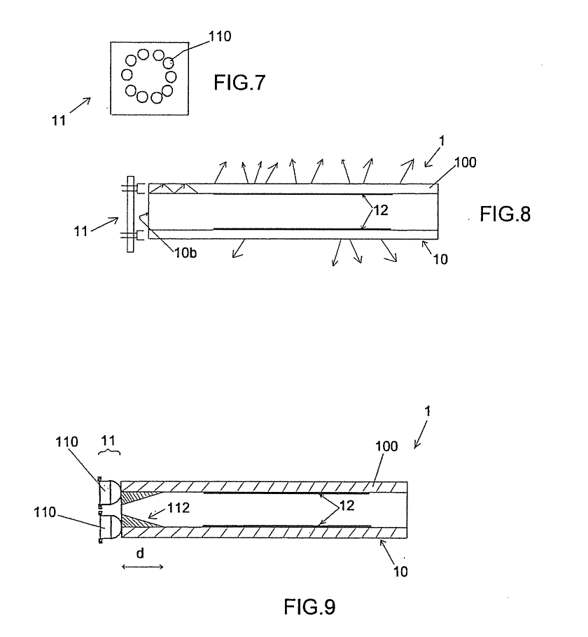

A further embodiment is represented in FIGS. 7 and 8, in which the light source 11 includes several light elements 110, such as electroluminescent diodes, arranged so as to form a ring. This ring of electroluminescent diodes 110 is positioned in front of the entrance 10b of the guide 10, the diodes 110 being positioned at a right angle to and substantially in contact with the wall 100 of the guide 10. In this embodiment, the diodes 110 have a small emission angle, for example in the order of 30°, such that the light produced is injected directly into the wall 100 of the guide 10, without it being necessary to implement an injector 112 or equivalent, as shown in the embodiment of FIG. 1.

A further embodiment is shown in FIG. 9, in which the light source 11 includes also several light elements 110, such as electroluminescent diodes, which are also arranged so as to form a ring, but which, in contrast to the embodiment of FIG. 8, are characterised by a large emission angle (for example in the order of 90°) and/or by an emission width greater than the thickness (e) of the wall 100 of the guide 10. In this case, in a manner identical to that described for the embodiment of FIG. 1, an injector 112 is implemented.

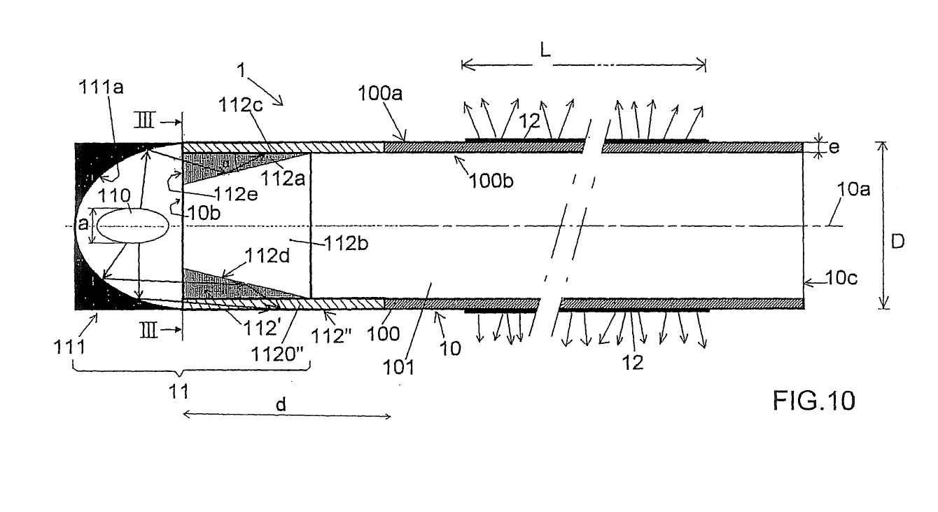

A further embodiment is shown in FIG. 10, in which the optical injection means 112 are constituted by two elements 112′ and 112″. The first element 112′ is identical to the injector 112 described above for the embodiment of FIG. 1. The second element 112″ is an intermediate, hollow, tubular guide, with the same diameter, and the same wall thickness as the guide 10. This guide 112″ is positioned at the extrmity of the principal guide 10 and extends this guide 10. The first element 112′ is nested in the interior of the intermediate guide 112″. The first element 112′ and the intermediate guide 112″ are made of different materials, having different indices of refraction. The index of refraction n3 of the first element is preferably less than the index of refraction n′3 of the wall 1120″ of the intermediate guide 112″, and this index n′3 of the wall 1120″ of the intermediate guide 112″ is preferably close to the index of refraction n1 of the wall 100 of the principlal guide 10. For example, in a non-limiting manner according to the invention, the first element 112′ is made of PPMA with an index of refraction n3 with a value of 1.49; the intermediate guide 112″ is made of polycarbonate with an index of refraction n′3 with a value of 1.58; the wall 100 of guide 10 is made of glass with an index of refraction n1 with a value of 1.47.

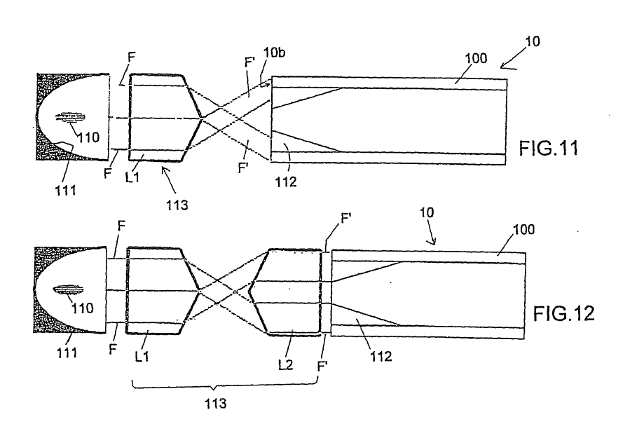

A further embodiment is shown in FIG. 11, in which the optical injection means include, in addition to injector 112, an axicon 113 interposed between the point light source 110/reflector 111 assembly and the entrance of the injector 112. This axicon 113 is aligned with the principal guide 10 and the injector 112, and allows the entry beam (F) produced by the point light source 110 associated with the reflector 111 to be transformed into an exit beam F′ with an annular shape. In the embodiment of FIG. 11, the axicon 113 is constituted by a single cylindrical lens LI and the secondary beam F′ is not collimated.

A further embodiment is shown in FIG. 12, in which the optical injection means include an axicon 113 with two cylindrical lens L1 and L2. The structure of the axicon 113 of the embodiment of FIG. 12 is more complex than that of the embodiment of FIG. 11, but it is an advantage if the exit beam F′ of the embodiment of FIG. 12 is collimated.

The device for producing light according to the invention can be used in all applications where it is necessary to have an extended light source that is preferably (but not necessarily) homogeneous. It can be used as a means of direct lighting. In general it can be used in all light signage devices. In particular it can be used to realise luminous signs, for example pharmacy's crosses, either by being used directly to make a luminous pattern, or as a means of retro-lighting (back-lighting of a translucent support bearing a pattern). In particular, but not exclusively, the device of the invention can be used to advantage to replace neon tubes, in all applications where this type of tube is implemented nowadays.

The invention is not limited to the particular embodiments shown in the attached figures. In particular, and in a non-exhaustive manner, the principal wave guide 10 can be rigid or flexible (optical fibre type) and according to its use can be rectilinear or have a relatively complex curved shape. The principal wave guide 10 is not necessarily a hollow tube, but can be replaced by any wave guide that includes an envelope for guiding and propagating light, and an internal part made out of one or several materials or different fluids of material constituting this envelope, the interior of the guide 10 not necessarily containing air. In the same way, the internal cavity 112a of the injector 112 does not necessarily contain air, but can be made of a material or contain a fluid the index of refraction of which is less than the index of refraction n3 of the wall 112a of the insert 112.

1-26. (canceled)

27. A device for producing light comprising at least one first light source associated with a principal wave guide, wherein the principal wave guide includes an envelope for the propagation of the light, said envelope having an index of refraction greater than the index of refraction of the internal part of the principal guide that is in contact with the envelope, and in that the device includes optical injection means that are separate from the principal wave guide, the length of which is less than the length of the principal wave guide, and which allow at least a part of the light produced to be injected into said envelope of the principal wave guide, and diffusion means that are suitable for diffusing at least a part of the light circulating in the envelope of the principal guide towards the exterior of the envelope, on at least a portion of the envelope with a predefined length.

28. The device for producing light according to claim 27, wherein the principal wave guide comprises a hollow tube, the wall of which forms the envelope for the propagation of the light.

29. The device for producing light according to claim 28, wherein the tube is made of glass or of a polymer material, and contains air.

30. The device for producing light according to claim 27, wherein the optical injection means are designed to inject at least 50%, and preferably at least 70%, of the light produced by the light source into said envelope of the principal wave guide.

31. The device for producing light according to claim 27, wherein the optical injection means include an injector that allows at least a part of the light beams produced by the light source to be guided by successive internal reflections.

32. The device for producing light according to claim 31, wherein the injector comprises an insert.

33. The device for producing light according to claim 32, wherein the insert includes an internal cavity in the shape of a truncated cone, the wall of which has a thickness that decreases substantially linearly from the entrance face of the principal guide.

34. The device for producing light according to claim 33, wherein the external surface of the insert is cylindrical, and in that the angle α of the insert between the external cylindrical surface and the internal surface of the insert is less than or equal to 11°, and preferably substantially equal to 11°.

35. The device for producing light according to claim 33, wherein the index of refraction of the insert is less than the index of refraction of the envelope of the principal wave guide.

36. The device for producing light according to claim 33, wherein the index of refraction of the insert is greater than the index of refraction of the envelope of the principal wave guide, and in that the injector includes an intermediate layer for adaptation of the index at the interface between the insert and the guide, said layer having an index of refraction less than the index of refraction of the envelope of the principal wave guide.

37. The device for producing light according to claim 27, wherein the optical injection means include an intermediate guide that comprises a propagation envelope with an index of refraction greater than the index of refraction of the internal part of the intermediate guide that is in contact with the envelope, and greater than the index of refraction of the envelope of the principal wave guide, said intermediate guide being interposed between the insert and the principlal wave guide.

38. The device for producing light according to claim 32, wherein the wall of the insert is made of polycarbonate or of PMMA, and the envelope of the principal wave guide is made of glass.

39. The device for producing light according to claim 27, wherein at least the first light source forms a ring of light.

40. The device for producing light according to claim 39, wherein at least the first light source includes several light elements arranged in the form of a ring.

41. The device for producing light according to claim 27, wherein at least the first light source includes a point light source associated with a reflector.

42. The device for producing light according to claim 39, wherein the reflector allows the light rays produced by the point source to be collimated in the form of a ring of light.

43. The device for producing light according to claim 27, wherein it includes at least a second reflector mounted at the extremity of the principal guide that is opposite the first light source.

44. The device for producing light according to claim 43, wherein it includes a second injector associated with the second reflector.

45. The device for producing light according to claim 44, wherein it includes a second point light source associated with the second reflector.

46. The device for producing light according to claim 27, wherein at least the first light source includes an axicon.

47. The device for producing light according to claim 27, wherein the diffusion means are realized at least in part on the internal surface of the envelope of the principal wave guide.

48. The device for producing light according to claim 27, wherein the diffusion means are located outside the injection region of the optical injection means.

49. The device for producing light according to claim 27 to be used as a means of direct lighting.

50. The device for producing light according to claim 27 to be used as a means of retro-lighting.

51. The device for producing light according to claim 27 to be used as a means of lighted signage.

52. A lighted signage device, in particular a luminous sign, and more particularly a pharmacy's cross, characterised in that it includes at least one device for producing light according to claim 27.
